(19) United States
(12) Patent Application Publication
(10) Pub. No.: US 2024/0031769 A1
(43) Pub. Date: Jan. 25, 2024

(54) GEOGRAPHIC AREA BASED UPLINK INTERFERENCE MITIGATION MANAGEMENT

(71) Applicant: T-Mobile USA, Inc., Bellevue, WA (US)

(72) Inventors: Roopesh Kumar Polaganga, Bothell, WA (US); Deepak Nadh Tammana, Bothell, WA (US)

(21) Appl. No.: 17/868,520

(22) Filed: Jul. 19, 2022

(51) Int. Cl. H04W 4/021; H04B 17/336; H04W 36/20

(52) U.S. Cl. CPC H04W 4/021; H04B 17/336; H04W 36/20

(57) ABSTRACT

Described herein are techniques, devices, and systems for mitigating uplink interference in cellular communications. Layers can be mapped to sectors based on ranks of the sectors and ranks of the layers. The ranks of the sectors can be identified based on load levels associated with the sectors. The ranks of the layers can be identified based on bandwidth levels associated with the layers. A geographic area can be identified to modify layers utilized by the mobile devices latched to an identified sector, based on the mapped layers.

### BACKGROUND

In 5G and other cellular systems, cellular frequencies including sets of frequency ranges, such as frequency ranges within an ultra high frequency band, may be utilized for exchanging communications between cellular-compatible mobile devices. Cellular networks may be distributed over geographic areas which may be served by fixed-location base transceiver stations. The base stations may provide the geographic areas with network coverage which may be used for transmission of voice, data, and other types of content.

Multiple frequencies with corresponding base stations may be utilized to provide communications to mobile devices in the geographic areas. The frequencies assigned to each geographic area may be reused for other non-adjacent geographic areas. One issue resulting from this frequency reuse may be the occurrence of interference between uplink communications for mobile devices in the geographic area and the adjacent geographic areas. While handovers between communication channels may be performed to maintain service quality, the handovers may be ineffective at successfully mitigating interference, and may result in other issues, such as data loss and connectivity problems.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 schematically illustrates an example network environment for geographic area based uplink interference mitigation management, in accordance with some examples of the present disclosure.

FIG. 2 schematically illustrates an example network environment for geographic area based uplink interference mitigation management, in accordance with some examples of the present disclosure.

FIG. 3 is a block diagram of example mapping for sectors and layers for geographic area based uplink interference mitigation management, in accordance with some examples of the present disclosure.

FIG. 4 illustrates a flowchart of geographic area based uplink interference mitigation management, in accordance with some examples of the present disclosure.

FIG. 5 is a block diagram of an example server computer utilized to implement management systems, in accordance with some examples of the present disclosure.

### DETAILED DESCRIPTION

The systems, devices, and techniques described herein can be implemented in a number of ways. References are made to the accompanying drawings that form a part hereof, and in which are shown by way of illustration specific configurations or examples, in which like numerals represent like elements throughout the several figures.

Wireless carriers (sometimes called “service providers” or “operators”) provide their users (sometimes called “subscribers” or “customers”) with access to a variety of types of services over a telecommunication network. Users expect to be able to access those services with adequate signal quality. Carriers may also identify different cells utilized by mobile devices in geographic areas (sometimes referred to as “hexagonal areas” or “hex-bins”) of an environment, and frequencies (sometimes called “layers” or “channels”) to manage communications for the mobile devices. The carriers can utilize physical cell identifiers (IDs) (PCIs) to identify cells, and evolved universal mobile telecommunications system (UMTS) terrestrial radio access (E-UTRA) absolute radio frequency channel numbers (EARFCNs) to identify the layers.

As noted above, multiple frequencies assigned to each geographic area may be different from adjacent, neighboring geographic areas. Service quality for communications to the mobile devices may be managed by tracking key performance indicators (KPI)/metrics based on cell traces, per call measurement data (PCMD), and mobile device reported metrics. The frequencies assigned to each geographic area may be reused for other non-adjacent geographic areas to enable the carriers to provide communication services for a greater density of mobile devices. Frequency reuse schemes may be utilized, as a result of naturally diminishing strengths of radio waves with distances from the base stations, to provide isolation among signals that use the same frequency.

Sizes of geographic areas may be determined by the carriers to provide varying granularities of geographic area coverage. The carriers may utilize more concentrated smaller geographic areas for more densely populated areas, such as urban areas or areas with tall buildings, and larger geographic areas with larger radii for less densely populated areas, such as rural areas or flat areas without tall buildings. Data, such as cellular characteristics and/or location data, may be received from the mobile devices in each geographic area. The data received from the mobile devices in the geographic area can be consolidated and utilized to identify the KPIs/metrics from the UEs to evaluate that particular geographic area. Carriers may manage cell configuration by utilizing the KPIs/metrics for capacity planning or coverage analysis.

However, while the KPIs/metrics may be utilized for cell configuration management, carriers may not be able to sufficiently mitigate interference dynamically according to existing technology. As a result, service quality may decrease due to interference resulting from variations in numbers of mobile devices in each geographic area and/or variations in signal parameters, such as types of frequencies, used by the mobile devices.

Techniques described herein are directed to mitigating uplink interference in cellular communications based on network information associated with the communications exchanged for the mobile devices and geographic areas utilized by the mobile devices. The network information can include characteristics associated with sectors to which the mobile devices are latched, and layers utilized by the mobile devises for exchanging communications. The layers can be mapped to the sectors based on ranks of the sectors and ranks of the layers. The ranks of the sectors can be identified based on load levels associated with the sectors. The ranks of the layers can be identified based on bandwidth levels associated with the layers. A geographic area can be identified to modify layers utilized by the mobile devices latched to the identified sector. The layers utilized by the mobile devices can be modified based on measurement results associated with characteristics of communications exchanged for the mobile devices latched to the identified sector.

The geographic area can be identified to modify layers utilized by mobile devices in the geographic area based on interference information associated with the mobile devices. The interference information can include measurement results associated with interference associated with communications exchanged for the mobile devices. In some examples, the measurement results can include results associated with levels of interference associated with the communications of the mobile devices. The levels of interference can be compared to other levels of interference associated with other mobile devices of other geographic areas. The geographic area can be identified and utilized to modify layers of the mobile devices in the geographic area based on the levels of interference of the geographic area being equal to or greater than the other levels of interference associated with the other geographic areas.

The interference information utilized to identify the geographic area to modify the layers utilized by mobile devices in the geographic area can include various types of information. The interference information can include physical cell identity (PCI) information and signal to interference plus noise ratio (SINR) information associated with mobile devices latched to a sector. The PCI information can include a total number of physical cell identities (PCIs) information. The SINR information can include an average signal to interference plus noise ratio (SINR) information. The interference information can be identified to modify layers utilized by the mobile devices latched to the sector.

Network information including sector information and layer information can be identified to modify the layers utilized by the mobile devices in the geographic area. Identifying the network information to modify the layers utilized by the mobile devices in the geographic area can include identifying sectors serviced by corresponding base stations in an environment including the geographic area. The sectors being identified can include the sectors associated with mobile devices located in the geographic area, and other sectors associated with other mobile devices located in the adjacent geographic areas.

Identifying the network information to modify the layers can include identifying layers utilized by mobile devices in the environment. The layers being identified can include layers utilized by mobile devices in the geographic area, and other layers utilized by other mobile devices in other geographic areas. The identified layers utilized by mobile devices in the geographic area can include layers associated with cellular signals being routed for the mobile devices as communications associated with the corresponding base stations.

Layer mapping information including sector ranks and layer ranks can be identified to map the layers utilized by the mobile devices in the environment to sectors to which the mobile devices are latched. Identifying the layer mapping information can include identifying ranks associated with the sectors, based on load levels associated with the sectors. Identifying the layer mapping information can include identifying ranks associated with the layers, based on bandwidth levels associated with the layers. The layers associated with the mobile devices in the environment can be mapped to the sectors to which the mobile devices in the environment are latched based on the layer ranks and the sector ranks. The layers can be mapped to the sectors based on levels of the layer ranks matching respective levels of the corresponding sector ranks.

Characteristics utilized to exchange communications with the mobile devices in the identified geographic area can be modified based on the mapped layers. The characteristics can be modified in different ways based on mobile devices in the identified geographic area being in different modes, including an active mode or an idle mode.

Modifying the characteristics utilized to exchange the communications with the mobile devices in the identified geographic area operating in the active mode can include transmitting signals indicating modified layers to be utilized by the mobile devices, based on the mapper layers. The layers to be utilized by the mobile devices can be identified as the modified layers based on identifying the layers to be mapped to corresponding sectors to which the corresponding mobile devices are latched. The signals indicating the layers to be utilized by the mobile devices in the active mode can be transmitted as handover messages. The signals indicating the layers to be utilized by the mobile devices in the idle mode can be transmitted as configuration messages, which can include dedicated priorities to be utilized after sessions currently being utilized by the mobile devices end.

By implementing a layer modifying procedure that identifies mapped layers and modifies the layers utilized by mobile devices in an identified geographic area based on the mapper layers, the mobile devices can be selectively transitioned to the modified layers if continuing to utilize the current layers would otherwise result in a degradation, or a loss, of service for the mobile devices. The layers can be dynamically modified in real-time or near real-time, based on changes in numbers of mobile devices in the geographic area or other geographic areas, as well as changes in sectors and/or layers associated with the mobile devices. Meanwhile, service quality for other mobile devices in other geographic areas that are utilizing similar or different layers as the mobile devices in the identified geographic areas can be maintained. Thereby, overconsumption of resources that otherwise would occur according to existing technology due to large numbers of mobile devices being located in similar geographic areas and utilizing the same sectors and/or layers can be avoided.

Furthermore, the techniques and systems described herein allow wireless carriers to continue availing themselves of the benefits of using frequency reuse schemes, instead of increasing types of frequencies being used as a means of circumventing the potential uplink quality issues associated with frequency reuse, as described herein. The techniques, devices, and systems described herein may further allow one or more devices to conserve resources with respect to processing resources, memory resources, networking resources, power resources, etc., in the various ways described herein. For example, by modifying layers utilized by mobile devices in an identified geographic area to improve uplink throughput, a UE and/or a base station may conserve processing resources, battery power, and the like by avoiding frequent handovers and/or retries to re-establish communication sessions, which may occur if layers were blindly assigned to mobile devices without concern for variations in numbers of mobile devices being located in similar geographic areas and utilizing the same layers.

### Illustrative Systems for Geographic Area Based Uplink Interference Mitigation Management

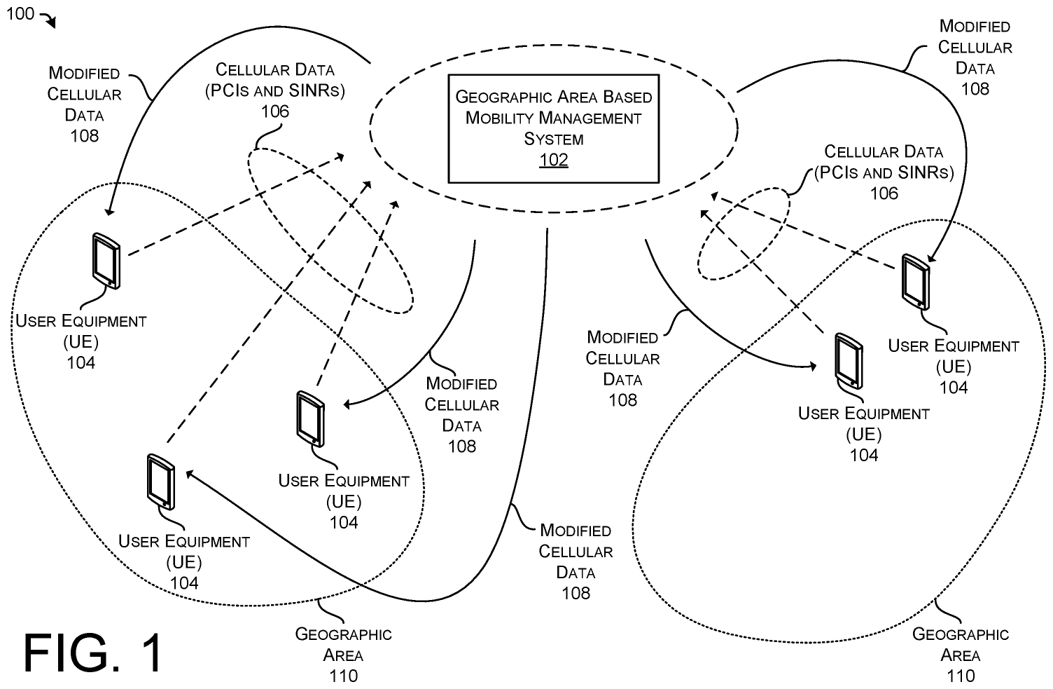

FIG. 1 schematically illustrates an example network environment 100 for geographic area based uplink interference mitigation management, in accordance with some examples of the present disclosure.

The network environment 100 can include a geographic area based mobility management system (e.g., a wireless carrier management system) (or “management system”) 102. The management system 102 can be utilized to manage services (e.g., network services) for user equipment (UEs) (e.g., mobile devices) 104. The services can be utilized to manage communications (or “communications”) associated with the UEs 104. The management system 102 can receive, from the UEs 104, cellular data 106, which can include metrics including one or more cell identifiers (e.g., physical layer cell identifiers (IDs) (PCIs)) and/or one or more other metrics (e.g., signal to interference plus noise ratios (SINRs)) utilized to manage services associated with the UEs 104.

The PCIs and the SINRs can be utilized to identify information associated with services being provided to the UEs 104. In some examples, a PCI can identify a cell in a physical layer of a network (e.g., a 5G network, or other type of network). The PCI can be identified based on a primary synchronization signal (PSS) and a secondary synchronization signal (SSS), and which can be utilized for separation of different transmitters.

In some examples, an SINR can include a ratio between a power level of a usable uplink signal, and a power level of a combination of interference and background noise. A value of the SINR can be indicative of a quality associated with an uplink connection, with relatively higher SINR values indicating relatively higher transmission power levels and/or relatively lower interference and noise.

The network services for the UEs 104 can be managed based on geographic areas 110 (e.g., hexagonal areas) (or “hex-bins”) in which the UEs 104 are located. The geographic areas 110 can be identified as sectors to which UEs 104 in the identified geographic area 110 are latched. The geographic areas 110 can include layers utilized by the UEs 104 in the geographic areas 110 for exchanging communications.

The sectors utilized by the UEs 104 can be associated with corresponding sites (e.g., base stations) utilized to route signals for communications exchanged for the UEs 104. The sectors associated with the base stations can be defined by carriers utilizing the base stations to provide communication services to the UEs 104. The sectors can be defined by radio frequency coverage data of the carriers, and can include a portion (e.g., a partial portion or an entire portion) of a total coverage area of the corresponding base stations. The layers, which can be utilized to exchange communications including data for the UEs 104, can be associated with corresponding frequency bands.

The geographic areas 110 can be ranked based on the cellular data 106. In some examples, the geographic areas 110 can be ranked based on ranking information associated with measurement data, which can include one or more metrics. The metric(s) utilized to rank the geographic areas 110 can include PCIs and the SINRs.

The ranking information can be identified based on relationship information between PCIs and carrier frequency values (e.g., evolved universal mobile telecommunications system (UMTS) terrestrial radio access (E-UTRA) absolute radio frequency channel number (EARFCNs) (e.g., new radio (NR)-ARFCNs (NR-ARFCNs)) associated with the UEs 104. The relationship information between the PCIs and the EARFCNs can indicate PCIs associated with a handover window of a predetermined size and associated with the same corresponding EARFCNs. By way of example, identifying the PCIs can include identifying, for each PCI, the PCI associated with the handover window of the predetermined size and associated with the corresponding EARFCN (e.g., a different PCI associated with the handover window and with each individual EARFCN can be identified).

In some examples, a size of the handover window can be the predetermined handover window size (e.g., operator determined size) (e.g., four-six decibel-milliwatts (dBm)). However, the disclosure is not limited as such. In some examples, the handover window size can be any size (e.g., one-three dBm, two-four dBm, three-five dBm, five-seven dBm, etc.).

In some examples, the EARFCNs can include various types of EARFCNs associated with various frequency bands (e.g., an advanced wireless services (AWS) band (e.g., a band b4), a personal communications service (PCS) band (e.g., a band b2), a band 71 (B71), a band 12 (B12), etc.). In some examples, the frequency bands utilized by the UEs 104 can include various frequency bands associated with various types of networks (e.g., one or more of a long term evolution (LTE) network, a fifth generation (5G) network, etc.)).

The ranking information can include, for the geographic areas 110, total numbers of the identified PCIs associated with the handover window of the predetermined size and with the same corresponding EARFCNs associated with the corresponding geographic areas 110. The ranking information can include average SINRs associated with the corresponding geographic areas 110 based on the SINRs associated with the corresponding geographic areas 110. The average SINR being identifying by averaging the SINRs associated with the corresponding geographic areas 110.

In some examples, the geographic areas 110 can be ranked based on the ranking information (e.g., the total numbers of the identified PCIs and the average SINRs associated with the corresponding geographic areas 110). By way of example, a geographic area 110 can be ranked based on i) a total number of PCIs associated with the handover window of the predetermined size and with the same corresponding EARFCNs associated with the geographic area 110, and ii) the average SINR associated with the geographic area 110.

The geographic areas 110 associated with respectively higher values of total numbers of the identified PCIs and respectively lower values of average SINRs can be ranked higher than other geographic areas 110 associated with respectively lower values of total numbers of the identified PCIs and respectively higher values of average SINRs. The geographic areas 110 can be ranked to flag a geographic area as being associated with interference above a desired and/or threshold level.

In some examples, a geographic area 110 can be identified based on i) a total number of the identified PCIs of the geographic area 110 being greater a threshold number of PCIs, and ii) an average SINR value of the geographic area 110 being less than a threshold SINR level. In those or other examples, the identified geographic area 110 can be based on i) the total number of the identified PCIs of the geographic area 110 being greater than other numbers of other identified PCIs associated with other geographic areas 110, and ii) the average SINR value of the geographic area 110 being less than other SINR levels associated with the other geographic areas 110.

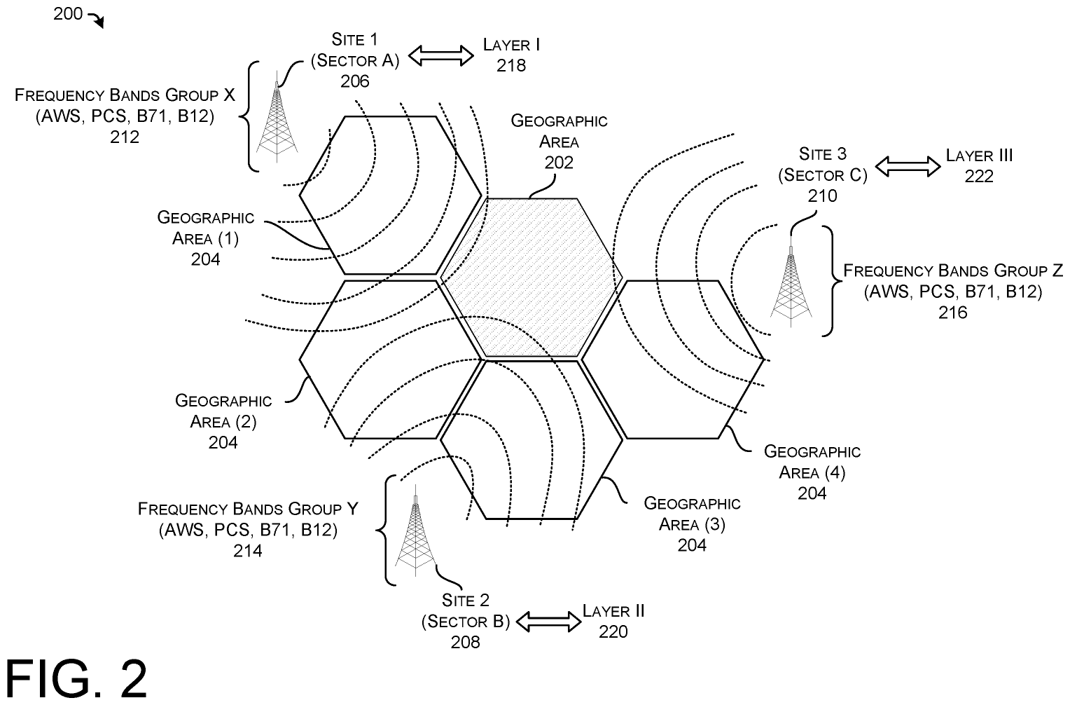

Although the identified geographic area 110 can be utilized for managing network services as discussed below in this disclosure, it is not limited as such. In some examples, the geographic area 110 being identified can be flagged as a flagged geographic area and utilized to implement any of the techniques as discussed herein, in a similar way as for the identified geographic area 110 (e.g., the geographic area 202, as discussed with reference to FIG. 2).

Managing network services can include identifying characteristics (e.g., cellular characteristics) (or “connection characteristics”) and/or location information associated with the UEs 104. The cellular characteristics and/or the location information can be identified via, and/or received in, the cellular data 106. The cellular characteristics, which can be utilized by the management system 102 to provide the services management, can include sector data including identifiers (or “sector identifiers”) of sectors to which the UEs 104 are latched, and/or layers data including identifiers (or “layers identifiers”) of layers utilized by the UEs 104 for exchanging communications. The location information can include location identifiers (e.g., identifiers indicating locations of the UEs 104). Location identifiers can include global positioning system (GPS) coordinates, and/or any other type of location data.

The management system 102 can utilize the cellular data 106, including the sector data and/or layer data, to identify modified cellular data 108. The sector data can be utilized to identify, and/or can include, sector identifiers associated with the geographic areas 110. The layer data can be utilized to identify, and/or can include, layers identifiers associated with layers utilized by UEs 104 in the geographic areas 110. The sector identifiers associated with the identified geographic area 110 can identify the sectors to which UEs 104 in the identified geographic area 110 are latched. The layer identifiers associated with the identified geographic area 110 can identify the layers utilized by the UEs 104 in the identified geographic area 110 for exchanging communications.

The cellular data 106 can be utilized to identify mapping information (or “layer mapping information”) based on the layers and the sectors to which the UEs 104 are latched. The layer mapping information can include ranks (or “sector ranks”) associated with the sectors and ranks (or “layer ranks”) associated with the layers. The sector ranks can be identified based on load levels (e.g., levels of load resulting from services provided to the UEs 104) associated with the sectors. The layer ranks can be identified based on bandwidth levels associated with the layers.

The mapping information can be utilized to compare the layer ranks relative to the sector ranks. The layers can be mapped to the sectors based on levels of the layer ranks matching respective levels of the corresponding sector ranks. The layers being mapped to the sectors can include the layers utilized by the UEs 104 in the identified geographic area 110 being mapped to the sectors to which the UEs 104 in the identified geographic area 110 are latched, based on the mapping information. By way of example, a layer can be mapped to a sector based on the layer rank (e.g., a highest layer rank) matching the sector rank (e.g., a highest sector rank). The layers being mapped can be identified as mapped layers (or “modified layers”) (or “selected layers”) in the modified cellular data 108.

The modified cellular data 108 can be identified based on the mapped layers. The cellular data 106, such as the layers utilized by the UEs 104 in the identified geographic area 110, can be modified as the modified cellular data 108 including the modified layers. Identifying the modified cellular data 108 can include modifying the layers utilized by the UEs 104 based on corresponding sectors to which the UEs 104 are latched to be modified layers to be utilized by the UEs 104. The layers of the cellular data 106 being modified to be the modified layers of the modified cellular data 108 can be based on the layer mapping information.

Modifications of the layers identified in the cellular data 106 to be the modified layers identified in the modified cellular data 108 can be can performed in different ways. The modifications can be performed differently based on UEs 104 in the identified geographic area 110 being in different modes. The modes can include, for example, an active mode and an idle mode. Modifying the characteristics utilized to exchange the communications with the UEs 104 in the identified geographic area 110 operating in the active mode can include transmitting signals indicating modified layers to be utilized by the UEs 104, based on the mapped layers.

The signals indicating the modified layers in the modified cellular data 108 to be utilized by the UEs 104 operating in the active mode can be transmitted as handover messages (e.g., radio resource control (RRC) reconfiguration messages). The signals indicating the modified layers in the modified cellular data 108 to be utilized by the UEs 104 operating in the idle mode can be transmitted as release messages (e.g., radio resource control (RRC) release messages), which can include dedicated priorities to be utilized after sessions currently being utilized by the UEs 104 end. The UEs 104 in the idle mode utilize the layers associated with the cellular data 106, until after a subsequent active session (e.g., until a subsequent active session ends).

In some examples, the modified cellular data 108 can be utilized by the management system 102 to overwrite any other layer management data. In those or other examples, the modified cellular data 108 can be utilized by the UEs 104, which can include UEs 104 assigned to cells via intra-frequency cell reselection or based on inter-frequency cell reselection.

In some examples, any of the modified layers and corresponding frequency bands in the modified cellular data 108 utilized by the UEs 104 can be associated with one or more types of networks (e.g., one or more of a long term evolution (LTE) network, a fifth generation (5G) network, etc.)). Any of the modified layers of the modified cellular data 108 can be the same as, or different from, layers of the cellular data 106.

Interference in uplink communications associated with the UEs 104 in the geographic areas 110 can be mitigated based on the modified cellular data 108. By mitigating the interference, the SINRs values associated with the UEs 104 in the identified geographic area 110 can be increased. Achieving relatively higher SINR values may enable base station capacity to be increased and higher order quadrature amplitude modulation (QAM) to be utilized, which may result in higher peak data rates, fewer dropped calls, and improved customer satisfaction.

Although various techniques are discussed utilizing the EARFCN as discussed above in this disclosure, it is not limited as such. In some examples, any of the techniques discussed herein can be implemented in similar way for any carrier frequency value (e.g., an NR-ARFCN) in a similar way as for the EARFCN.

FIG. 2 schematically illustrates an example network environment 100 for geographic area based uplink interference mitigation management, in accordance with some examples of the present disclosure.

The network environment 200 can include geographic areas (e.g., geographic areas 110, as discussed above with reference to FIG. 1), which can include a geographic area 202. In some examples, the geographic areas can include one or more geographic area (e.g., geographic areas (1)-(4)) 204. Services can be managed for one or more user equipment (UEs) (e.g., the UEs 104, as discussed above with reference to FIG. 1) in any of the geographic areas (e.g., the geographic area 202 and/or the geographic area(s) 204), by the management system (e.g., the management system 102, as discussed above with reference to FIG. 1). In some examples, any techniques as discussed herein with reference to FIG. 2 can be performed utilizing the management system 102 and/or one or more other management systems.

The geographic area 202, which initially can be one of the geographic area(s) 204, can be identified as the geographic area 202, in a similar way as for the identified geographic area 110, as discussed above with reference to FIG. 1. By way of example, the geographic area 202 can be identified based on interference information. The interference information utilized to identify the geographic area 202 can be identified via cellular data (e.g., the cellular data 106, as discussed above with reference to FIG. 1), which can include PCIs and SINRs associated with UEs 104 in the geographic area 202.

The interference information can be identified based on radio frequency (RF) data (e.g., the cellular data 106) received during a time period. The time period can be identified based on an initial time (e.g., a start time), and a current time (e.g., an end time) meeting or exceeding a threshold time period (e.g., an operator defined threshold).

In some examples, PCIs and SINRs associated with the UEs 104 in the geographic area 202 and/or the geographic area(s) 204 can be identified based on services being provided by the management system 102, via sites (e.g., base stations) 206, 208, and 210. In those or other examples, the site (e.g., site 1) 206 can be associated with a sector (e.g., a sector A), the site (e.g., site 2) 208 can be associated with a sector (e.g., a sector B), and the site (e.g., site 3) 210 can be associated with a sector (e.g., a sector C).

The UEs 104 in the geographic area 202 and/or the geographic area(s) 204 can include UEs 104 latched to various sectors. In some examples, the UEs 104 included in the geographic area 202 can include UEs 104 latched to the sector A, UEs 104 latched to the sector B, and UEs 104 latched to the sector C to exchange communications (as depicted in FIG. 2 by lines radiating out from sites 1-3). In those or other examples, the UEs 104 included in the geographic area (1) 204 can include UEs 104 latched to the sector A to exchange communications (as depicted in FIG. 2 by lines radiating out from site 1). In those or other examples, the UEs 104 included in the geographic area (2) 204 can include UEs 104 latched to the sectors A and B to exchange communications (as depicted in FIG. 2 by lines radiating out from sites 1 and 2). In those or other examples, the UEs 104 included in the geographic area (3) 204 can include UEs 104 latched to the sector B to exchange communications (as depicted in FIG. 2 by lines radiating out from site 2). In those or other examples, the UEs 104 included in the geographic area (4) 204 can include UEs 104 latched to the sector C to exchange communications (as depicted in FIG. 2 by lines radiating out from site 3).

In some examples, PCIs associated with EARFCNs identifying frequency bands utilized by the UEs 104 in the geographic area 202, and latched to sector A, can be identified based on frequency bands group X 212. The frequency bands group X 212 may include an advanced wireless services (AWS) (e.g., a band b4) band (e.g., a frequency band with a with a 20 megahertz (MHz) bandwidth), a personal communications service (PCS) band (e.g., a band b2) (e.g., a frequency band with a with a 10 megahertz (MHz) bandwidth), a band 71 (B71) (e.g., a frequency band with a with a 5 megahertz (MHz) bandwidth), and a band 12 (B12) (e.g., a frequency band with a with a 5 megahertz (MHz) bandwidth).

In those and other examples, PCIs associated with EARFCNs identifying frequency bands utilized by the UEs 104 in the geographic area 202, and latched to sector B, can be identified based on frequency bands group Y 214. The frequency bands group Y 214 may include the AWS band, the PCS band, the B71 band, and the B12 band.

In those and other examples, PCIs associated with EARFCNs identifying frequency bands utilized by the UEs 104 in the geographic area 202, and latched to sector C, can be identified based on frequency bands group Z 216. The frequency bands group Z 216 may include the AWS band, the PCS band, the B71 band, and the B12 band.

In some examples, the PCIs utilized by the UEs 104 in the geographic area 202, and latched to sector A, may include a PCI associated with an EARFCN identifying the AWS band, a PCI associated with the EARFCN and the PCS band, a PCI associated with the EARFCN and the B71 band, and a PCI associated with the EARFCN and the B12 band. In those or other examples, the PCIs utilized by the UEs 104 in the geographic area 202, and latched to sector B, may include a PCI associated with an EARFCN identifying the AWS band, a PCI associated with an EARFCN identifying the PCS band, a PCI associated with an EARFCN identifying the B71 band, and a PCI associated with an EARFCN identifying the B12 band. In those or other examples, the PCIs utilized by the UEs 104 in the geographic area 202, and latched to sector C, may include a PCI associated with an EARFCN identifying the AWS band, a PCI associated with an EARFCN identifying the PCS band, a PCI associated with an EARFCN identifying the B71 band, and a PCI associated with an EARFCN identifying the B12 band.

In those or other examples, a total number of the PCIs associated with EARFCNs utilized by the UEs 104 in the geographic area 202 may include 12. By way of example, the 12 PCIs may include 4 PCIs associated with EARFCNs identifying frequency bands utilized by the UEs 104 located in the geographic area 202 and latched to sector A; 4 PCIs associated with EARFCNs identifying frequency bands utilized by the UEs 104 being located in the geographic area 202 and latched to sector B; and 4 PCIs associated with EARFCNs identifying frequency bands utilized by the UEs 104 located in the geographic area 202 and latched to sector C.

In those or other examples, a total number of the PCIs associated with EARFCNs utilized by the UEs 104 in the geographic area 202 may be greater than a total number of the PCIs associated with EARFCNs utilized by the UEs 104 in individual ones of the geographic areas 204. By way of example, a total number of the PCIs associated with EARFCNs utilized by the UEs 104 in the geographic area (1) 204 may include 4 (e.g., 4 PCIs associated with EARFCNs identifying frequency bands utilized by the UEs 104 located in the geographic area 202 and latched to sector A. By way of another example, a total number of the PCIs associated with EARFCNs utilized by the UEs 104 in the geographic area (2) 204 may include 8 (e.g., 4 PCIs associated with EARFCNs identifying frequency bands utilized by the UEs 104 located in the geographic area 202 and latched to sector A; and 4 PCIs associated with EARFCNs identifying frequency bands utilized by the UEs 104 located in the geographic area 202 and latched to sector B).

By way of example, a total number of the PCIs associated with EARFCNs utilized by the UEs 104 in the geographic area (3) 204 can include 4 (e.g., 4 PCIs associated with EARFCNs identifying frequency bands utilized by the UEs 104 located in the geographic area 202 and latched to sector B). By way of example, a total number of the PCIs associated with EARFCNs utilized by the UEs 104 in the geographic area (4) 204 may include 4 (e.g., 4 PCIs associated with EARFCNs identifying frequency bands utilized by the UEs 104 located in the geographic area 202 and latched to sector C).

The interference information utilized to identify the geographic area 202 can include a total number of the identified PCIs (e.g., PCIs within a handover window of a predetermined handover window size, the PCIs being identified as being associated with corresponding EARFCNs) of the geographic area 202 being greater than a threshold number of PCIs, and an average SINR value of the geographic area 202 being less than a threshold SINR level. In some examples, the total number of the PCIs (e.g., PCIs within a handover window size identified as being associated with corresponding frequency bands associated with corresponding EARFCNs) of the geographic area 202 can be identified as 12, which can be identified as being greater than a threshold number of PCIs (e.g., three, six, etc.). In those or other examples, the average SINR value (e.g., 0, −10, −20, etc.) of the geographic area 202 can be identified as being less than a threshold SINR level (e.g., 20, 30, etc.).

In alternative or additional examples to identifying whether the total number of the identified PCIs of the geographic area 202 is greater than the threshold number of PCIs, the interference information utilized to identify the geographic area 202 can include a total number of identified PCIs of the geographic area 202 being identified as being greater than other numbers of identified PCIs associated with the geographic area(s) 204, and an average SINR value of the geographic area 202 being identified as being less than other SINR levels associated with the geographic area(s) 204. In those or other examples, the interference information utilized to identify the geographic area 202 can include the total number of identified PCIs of the geographic area 202 being greater than individual ones of numbers of identified PCIs associated with corresponding areas of the geographic area(s) 204, and the average SINR value of the geographic area 202 being less than individual ones of other SINR levels associated with corresponding areas of the geographic area(s) 204.

The geographic area 202 and the geographic area(s) 204 can be ranked based on geographic ranking area information, which can include geographic area ranks. The geographic area 202 associated with respectively higher values of total numbers of the identified PCIs and respectively lower values of average SINRs can be ranked higher than the geographic area(s) 204 associated with respectively lower values of total numbers of the identified PCIs and respectively higher values of average SINRs. The geographic area ranking information can be identified as including a geographic area rank associated with the geographic area 202 being greater than geographic area ranks associated with the geographic area(s) 204.

Identifying the geographic area 202 based on the geographic area ranking information can be utilized to modify the cellular data 106 (e.g., layers) utilized by the UEs 104 in the geographic area 202 to be the modified cellular data 108 (e.g., the modified layers). The cellular data 106 (e.g., layers) utilized by the UEs 104 in the geographic area 202 being modified as the modified cellular data 108 (e.g., the modified layers) can be based on layer mapping information, in a similar way as for the modified cellular data 108 being identified based on the layer mapping information, as discussed above with reference to FIG. 1.

The layer mapping information can include the sector load levels and the layer bandwidth levels. The sector ranks can be identified based on load levels associated with the sectors. By way of example, a load level associated with the UEs 104 in the geographic area 202 latched to sector B may be identified as being higher than a load level associated with the UEs 104 in the geographic area 202 latched to sector A, as well as a load level associated with the UEs 104 in the geographic area 202 latched to sector C. By way of another example, a load level associated with the UEs 104 in the geographic area 202 latched to sector A may be identified as being higher than a load level associated with the UEs 104 in the geographic area 202 latched to sector C. In those examples, the sector ranks can include a sector rank identified for the sector B, which may be higher than a sector rank identified for the sector A, which in turn may be higher than a sector identified for the sector C.

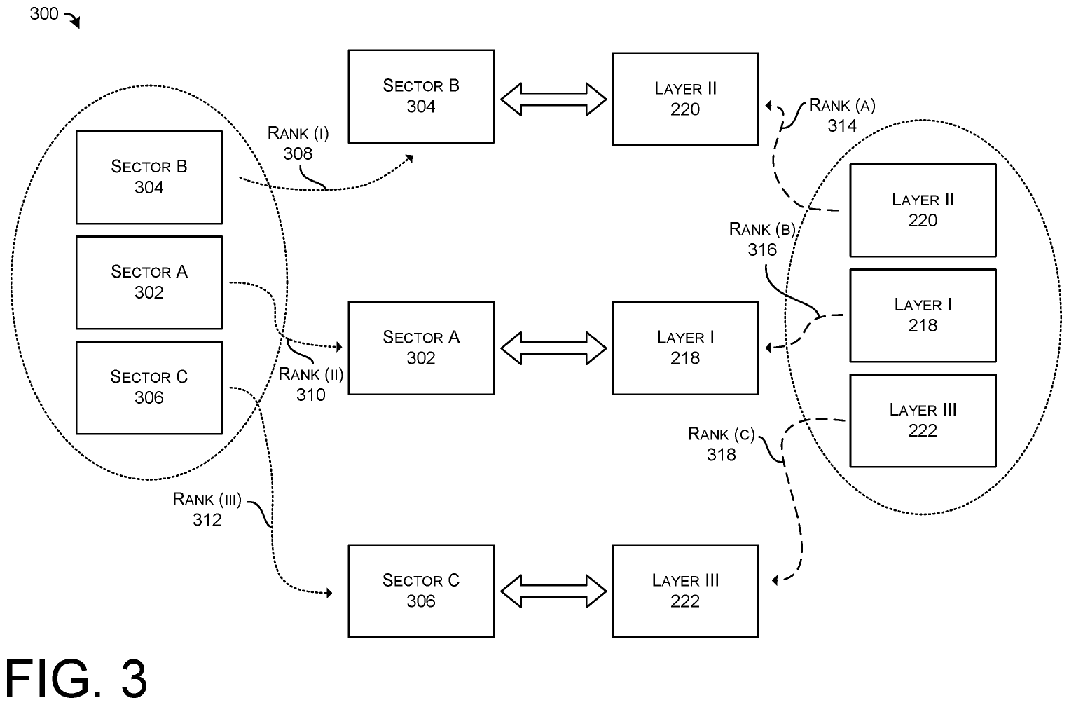

The layer ranks can be identified based on bandwidth levels associated with the layers, as discussed below with reference to FIG. 3 in further detail. In some examples, the layer mapping information can include a layer I (e.g., a first layer) (e.g., a layer associated with the band B4) 218, a layer II (e.g., a second layer) (e.g., a layer associated with the band B2) 220, and a layer III (e.g., a third layer) (e.g., a layer associated with the band B71) 222. In those examples, the layer mapping information can include a layer rank (e.g., a first layer rank) identified for the layer II 220, may be higher than a layer rank (e.g., a second layer rank) identified for the layer I 218, which in turn may be higher than a layer rank (e.g., a third layer rank) identified for the layer III 222.

The layer mapping information can be utilized to map the layers to the sectors based on the sector ranks and the layer ranks. By way of example, the sector B can be mapped to the layer II (e.g., the layer associated with the band B4) 220, the sector A can be mapped to the layer I (e.g., the layer associated with the band B2) 218, and the sector C can be mapped to the layer III (e.g., the layer associated with the band B71) 222.

Services associated with the UEs 104 in the geographic area 202 can be managed based on the modified cellular data 108. The layers of the cellular data 106 being modified to be the modified layers of the modified cellular data 108 can be based on the layer mapping information. Modifications of the UEs 104 from utilizing the layers identified in the cellular data 106 to the modified layers identified in the modified cellular data 108 can be can performed similarly as discussed above with reference to FIG. 1.

By modifying layers utilized by the UEs 104, via the mapped layers in the modified cellular data 108, handovers associated with the UEs 104 that communicate in a same geographic area 110 can be minimized or eliminated. By way of example, for sector A associated with site 1 206, there may be four EARFCNs (e.g., AWS, PCS, B71, B12) being utilized by the UEs 104 latched to sector A. Similarly, for sector B associated with site 2 208, there may be the same EARFCNs being utilized by the UEs 104 latched to sector B. As a result, the same four frequencies may repeated in all the geographic area 202 and the geographic areas 204. A UE 104 being located in the geographic area 202, for example, can utilize the AWS or the PCS EARFCN.

By performing layer mapping for the geographic area 202, the modified layer to be utilized by the UE 104 can be identified based on the modified cellular data 108. As a result, if the UE 104 is utilizing the AWS or PCS EARFCN, and if there is interference, the modified cellular data 108 can be identified to modify layers utilized by the UEs 104 in the geographic area 202, resulting in the UEs 104 utilizing the modified layers without interference. Therefore, any handovers, which may otherwise have occurred according to existing technology due to UEs 104 having insufficient information related to loads or frequencies of other sectors, and which may otherwise have resulted in additional interference and/or additional handovers, can be avoided.

FIG. 3 is a block diagram 300 of example mapping for sectors and layers for geographic area based uplink interference mitigation management, in accordance with some examples of the present disclosure. In some examples, the mapping for the sectors and layers, as depicted in FIG. 3, can be utilized for managing services for user equipment (UEs) (e.g., the UEs 104) located in the geographic area 202, as discussed above with reference to FIG. 2.

In some examples, the UEs 104 can include UEs 104 latched to the sector A 302 (e.g., the sector A associated with the site 1 206), UEs 104 latched to the sector B 304 (e.g., the sector B associated with the site 2 208), and UEs 104 latched to sector C 306 (e.g., the sector C associated with the site 3 210). In some examples, layer mapping information utilized to manage services for the UEs 104 can include the sector A 302, the sector B 304, and the sector C 306. In those examples, the layer mapping information can include a rank (i) 308 identified for the sector B 304, which may be higher than a rank (ii) 310 identified for the sector A 302, which in turn may be higher than a rank (iii) 312 identified for the sector C 306.

In some examples, the layer mapping information can include the layer I 218, the layer II 220, and the layer III 222, as discussed above with reference to FIG. 2. In those examples, the layer mapping information can include a layer rank (a) (e.g., a first layer rank) 316 identified for the layer II 220, a layer rank II 316 associated with the layer I 218, and a layer rank III 318 identified for the layer rank III 222. By way of example, the layer rank (b) 316 identified for the layer II 220 (e.g., the layer associated with the frequency band B4 having a bandwidth of 20 MHz), may be higher than the layer rank (c) 316 identified for the layer I 218 (e.g., the layer associated with the frequency band B2 having a bandwidth of 10 MHz), which in turn may be higher than the layer rank III 316 identified for the layer III 222 (e.g., the layer associated with the frequency band B71 having a bandwidth of 10 MHz).

The layer mapping information can be utilized to map the layers to the sectors based on the sector ranks and the layer ranks. By way of example, the sector B 304 (e.g., the sector in the geographic area 202 with the highest load) can be mapped to the layer II 220, the sector A 302 (e.g., the sector in the geographic area 202 with the second highest load) can be mapped to the layer I 218, and the sector C 306 (e.g., the sector in the geographic area 202 with the third highest load) can be mapped to the layer III 222.

In some examples, the mapping of the layers, including the layer II 220, the layer I 218, and the layer III 222, to the sectors, including the sector B 304, the sector A 302, and the sector C 306, can be performed dynamically (e.g., performed in real-time or near real-time). Dynamically performing the layer mapping can include the layer mapping being performed during services being utilized by the UEs 104, based on analysis of the interference information resulting in identification of the geographic area 202 (e.g., the geographic area 202 being identified based on identifying the total number of the PCIs of the geographic area 202 being greater than a threshold number of PCIs, and an average SINR value of the geographic area 202 being less than a threshold SINR level). The mapping being performed dynamically can include overwriting any and/or all other layer management of the management system 102.

Services associated with the UEs 104 in the geographic area 202 can be managed based on the modified cellular data 108. The layers of the cellular data 106 being modified to be the modified layers of the modified cellular data 108 can be based on the layer mapping information. Modifications of the UEs 104 from utilizing the layers identified in the cellular data 106 to the modified layers identified in the modified cellular data 108 can be can performed similarly as discussed above with reference to FIGS. 1 and 2.

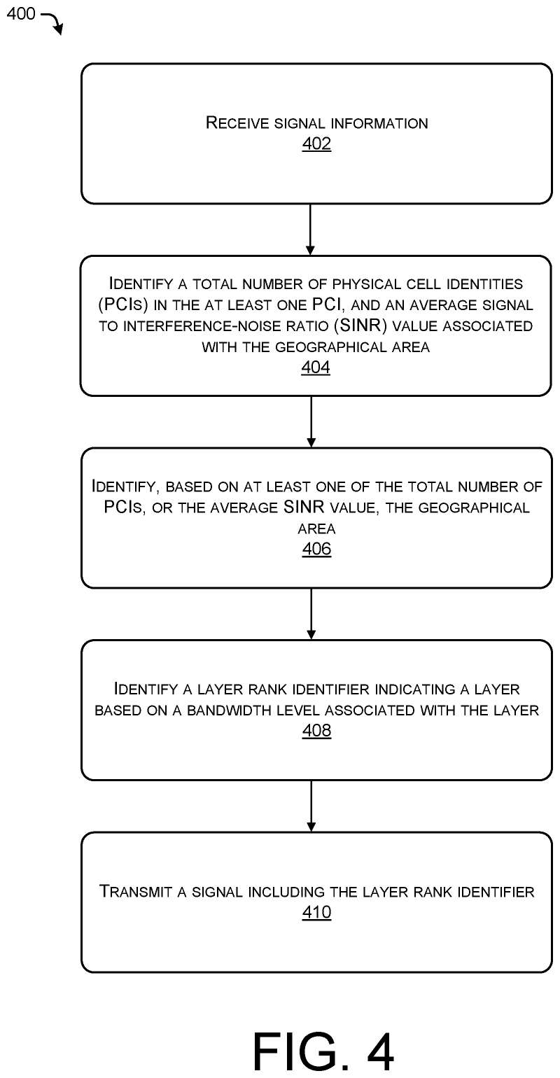

FIG. 4 illustrates a flowchart of geographic area based uplink interference mitigation management, in accordance with some examples of the present disclosure.

At least part of the process 400 may be performed by the management system 102, the UEs 104, the sites 206, 208, and 210, and/or by any other suitable computing device(s), as described herein.

At operation 402, the process can include receiving signal information. The signal information (e.g., the cellular data 106) can be associated with at least one user equipment (UE) 104 located in a geographic area 110.

At operation 404, the process can include identifying a total number of physical cell identities (PCIs) in the at least one PCI, and an average signal to interference plus noise ratio (SINR) value associated with the geographic area. The total number of PCIs can be based on PCIs (e.g., PCIs within a handover window of a predetermined size) being identified as being associated with corresponding frequency bands associated with corresponding EARFCNs received from the UEs 104 in the geographic area. The total number of PCIs and the average SINR value can be identified based on, and/or received in, the cellular data 106.

At operation 406, the process can include identifying, based on at least one of the total number of PCIs, or the average SINR value, the geographic area 202. The geographic area 202 can be identified based on at least one of the total number of PCIs being greater than a threshold number of PCIs, or the average SINR value being less than a threshold SNIR level.

At operation 408, the process can include identifying a layer rank identifier indicating a layer based on a bandwidth level associated with the layer. The layer rank identifier can be associated with a rank 314 of a layer 11220. The layer II 220 can be ranked higher than a layer I 218, based on a bandwidth level of the layer II 220 being greater than a bandwidth level of the layer I 218. The layer II 220 can be mapped to a sector B 304, based on a load of the sector B 304 being greater than a load of a sector A 302.

At operation 410, the process can include transmitting a signal including the layer rank identifier. The layer rank identifier can be transmitted via the modified cellular data 108. The layer II 220 associated with the layer rank identifier can be utilized by the UEs 104 latched to the sector B 304.

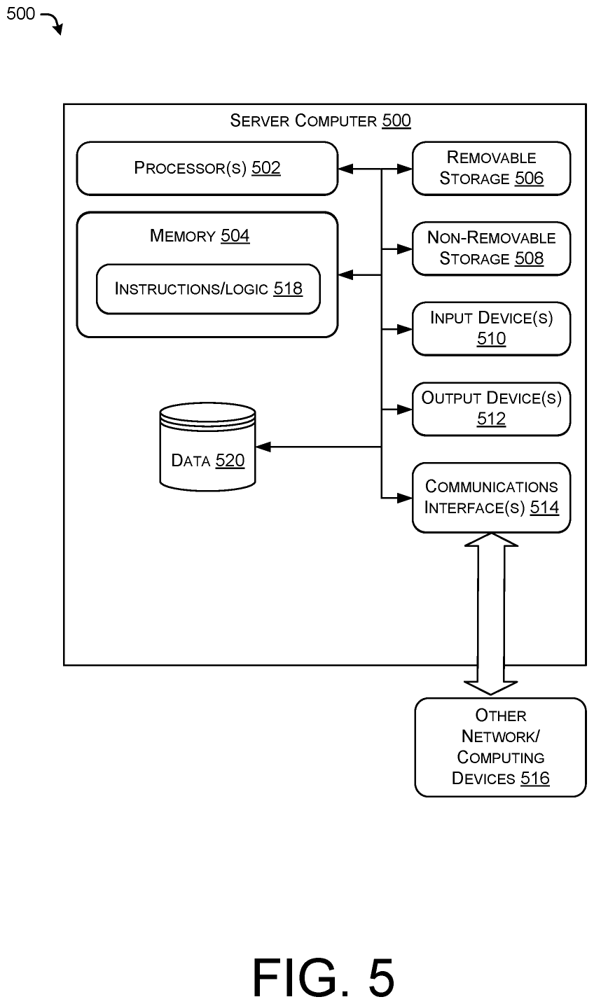

FIG. 5 is a block diagram of an example server computer 500 utilized to implement management systems, in accordance with some examples of the present disclosure. The server computer 500 may be representative of an individual node (or network element) (e.g., a node of a geographic area based mobility management system 102, as discussed above with reference to FIG. 1) or multiple nodes (or network elements) (e.g., multiple nodes of the geographic area based mobility management system 102) of a telecommunications network.

As shown, the server computer 500 may include one or more processors 502 and one or more forms of computer-readable memory 504. The server computer 500 may also include additional storage devices. Such additional storage may include removable storage 506 and/or non-removable storage 508.

The server computer 500 may further include input devices 510 (e.g., a touch screen, keypad, keyboard, mouse, pointer, microphone, etc.) and output devices 512 (e.g., a display, printer, speaker, etc.) communicatively coupled to the processor(s) 502 and the computer-readable memory 504. The server computer 500 may further include communications interface(s) 514 that allow the server computer 500 to communicate with other computing devices 516 (e.g., other nodes, a UE(s), etc.) such as via a network. The communications interface(s) 514 may facilitate transmitting and receiving wired and/or wireless signals over any suitable communications/data technology, standard, or protocol, as described herein.

In various embodiments, the computer-readable memory 504 comprises non-transitory computer-readable memory 504 that generally includes both volatile memory and non-volatile memory (e.g., random access memory (RAM), read-only memory (ROM), erasable programmable read-only memory (EEPROM), Flash Memory, miniature hard drive, memory card, optical storage, magnetic cassettes, magnetic tape, magnetic disk storage or other magnetic storage devices, or any other medium). The computer-readable memory 504 may also be described as computer storage media and may include volatile and nonvolatile, removable and non-removable media implemented in any method or technology for storage of information, such as computer readable instructions, data structures, program modules, or other data. Computer-readable memory 504, removable storage 506 and non-removable storage 508 are all examples of non-transitory computer-readable storage media. Computer-readable storage media include, but are not limited to, RAM, ROM, EEPROM, flash memory or other memory technology, compact disc read-only memory (CD-ROM), digital versatile disks (DVD) or other optical storage, magnetic cassettes, magnetic tape, magnetic disk storage or other magnetic storage devices, or any other medium which can be used to store the desired information and which can be accessed by the server computer 500. Any such computer-readable storage media may be part of the server computer 500.

The memory 504 can include logic 518 (i.e., computer-executable instructions that, when executed, by the processor(s) 502, perform the various acts and/or processes disclosed herein) to implement synchronization of subscriber data, according to various examples as discussed herein. For example, the logic 518 is configured to carry out signaling and/or communications associated with the management system 102 and the UEs 104, as discussed herein. The memory 504 can further be used to store data 520, which may be used to implement synchronization of subscriber data, as discussed herein. In one example, the data 520 may include network information (e.g., the network information, as discussed above with reference to FIG. 1) and/or mobile device information (e.g., the mobile device information, as discussed above with reference to FIG. 1).

The environment and individual elements described herein may of course include many other logical, programmatic, and physical components, of which those shown in the accompanying figures are merely examples that are related to the discussion herein.

The various techniques described herein are assumed in the given examples to be implemented in the general context of computer-executable instructions or software, such as program modules, that are stored in computer-readable storage and executed by the processor(s) of one or more computers or other devices such as those illustrated in the figures. Generally, program modules include routines, programs, objects, components, data structures, etc., and define operating logic for performing particular tasks or implement particular abstract data types.

Other architectures can be used to implement the described functionality, and are intended to be within the scope of this disclosure. Furthermore, although specific distributions of responsibilities are defined above for purposes of discussion, the various functions and responsibilities might be distributed and divided in different ways, depending on circumstances.

Similarly, software can be stored and distributed in various ways and using different means, and the particular software storage and execution configurations described above can be varied in many different ways. Thus, software implementing the techniques described above can be distributed on various types of computer-readable media, not limited to the forms of memory that are specifically described.

What is claimed is:

1. A method, comprising:
receiving signal information associated with at least one user equipment (UE) located in a geographic area, the signal information including at least one physical cell identity (PCI) and at least one signal to interference plus noise ratio (SINR);
identifying a total number of PCIs in the at least one PCI, and an average SINR value associated with the geographic area, the at least one PCI being included in a same handover window of a predetermined size and being associated with at least one carrier frequency value, the average SINR value being associated with the at least one SINR value of the at least one UE;
identifying, based on the total number of PCIs being greater than a threshold number of PCIs, and the average SINR value being less than a threshold SINR level, the geographic area;
identifying a sector rank identifier and a layer rank identifier, the sector rank identifier indicating a sector based on a load level associated with the sector, the layer rank identifier indicating a layer based on a bandwidth level associated with the layer; and
transmitting, to the UE and based on the layer rank identifier, a signal including a layer management identifier utilized to assign the UE to the layer, the layer being mapped to the sector based on the load level and the bandwidth level.

2. The method of claim 1, wherein, the layer is a first layer, the bandwidth level is a first bandwidth level, and identifying the layer rank identifier further comprises:
identifying the layer rank identifier as a first layer rank identifier;
identifying a second layer rank identifier associated with a second layer based on a second bandwidth level associated with the second layer;
identifying the first layer as a selected layer, based on the first bandwidth level being greater than the second bandwidth level; and
identifying the first layer rank identifier as the layer management identifier based on the first layer being identified as the selected layer.

3. The method of claim 1, wherein identifying the layer rank identifier further comprises:
mapping the layer to the sector, based on the sector rank identifier and the layer rank identifier;
identifying, based on the layer being mapped to the sector, and the UE being latched to the sector, the layer as a selected layer; and
identifying the layer rank identifier as the layer management identifier based on the layer being identified as the selected layer.

4. The method of claim 1, wherein the sector is a first sector, the UE is latched to the first sector, the load level is a first load level, and identifying the sector rank identifier further comprises:
identifying the sector rank identifier as a first sector rank identifier;
identifying a second sector rank identifier associated with a second sector based on a second load level associated with the second sector;
identifying the first sector as a selected sector, based on the first load level being greater than the second load level; and
identifying the layer rank identifier as the layer management identifier based on the layer being mapped to the selected sector to which the UE is latched.

5. The method of claim 1, wherein, the layer is a first layer, the bandwidth level is a first bandwidth level, the sector is a first sector, the load level is a first load level, and identifying the sector rank identifier the layer rank identifier further comprises:
identifying a second bandwidth level associated with a second layer;
identifying a second load level associated with a second sector; and
mapping the first layer to the first sector, based on the first bandwidth level being less than the second bandwidth level, and the first load level being greater than the second load level.

6. The method of claim 1, wherein, the layer is a first layer, the bandwidth level is a first bandwidth level, the sector is a first sector, the load level is a first load level, and identifying the sector rank identifier the layer rank identifier further comprises:
identifying a second bandwidth level associated with a second layer, and a second load level associated with a second sector;
identifying a third bandwidth level associated with a third layer, and a third load level associated with a third sector; and
mapping the first layer to the first sector, based on the first bandwidth level being less than the second bandwidth level and the third bandwidth level, and the first load level being greater than the second load level and the third load level;
mapping the second layer to the second sector, based on the second bandwidth level being less than the third bandwidth level, and the second load level being greater than the third load level; and
mapping the third layer to the third sector.

7. The method of claim 1, wherein the geographic area is a first geographic area, the total number of PCIs is a first total number of PCIs, the average SINR value is a first average SINR value, and identifying the first geographic area geographic area further comprises:
identifying the first geographic area as a first hexagonal cell;
identifying a second geographic area as a second hexagonal cell; and
identifying a second total number of PCIs and a second average SINR value associated with the second geographic area;
identifying the geographic area based on at least one of the second total number of PCIs being less than or equal to the threshold number of PCIs, or the second average SINR value being greater than or equal to the threshold SINR value.

8. The method of claim 1, wherein the at least one UE includes a first UE and a second UE, the at least one PCI includes a first PCI associated with the first UE and a second PCI associated with the second UE, the at least one SINR includes a first SINR associated with the first UE and a second SINR associated with the second UE, the layer includes a first layer, the sector includes a first sector, the signal includes a first signal, and the layer management identifier is utilized to assign the first UE to the first layer based on the first UE being latched to the first sector, further comprising:
transmitting, to the second UE and based on the second UE being latched to a second sector, a second signal including a second layer management identifier utilized to assign the second UE to the second layer, the second layer being mapped to the second sector.

9. A system, comprising:
at least one processor; and
memory storing instructions that, when executed by the at least one processor, cause the at least one processor to perform operations comprising:
receiving signal information associated with at least one user equipment (UE) located in a geographic area;
identifying a total number of physical cell identities (PCIs) in the at least one PCI, and an average signal to interference plus noise ratio (SINR) value associated with the geographic area, the at least one PCI being included in a handover window and being associated with at least one carrier frequency value, the average SINR value being associated with the at least one SINR value of the at least one UE;
identifying, based on at least one of the total number of PCIs being greater than a threshold number of PCIs, or the average SINR value being less than a threshold SNIR level, the geographic area;
identifying a layer rank identifier indicating a layer based on a bandwidth level associated with the layer; and
transmitting, to the UE, a signal including the layer rank identifier.

10. The system of claim 9, wherein the signal information includes at least one physical cell identity (PCI) and at least one SINR value associated with the geographic area.

11. The system of claim 9, wherein the at least one carrier frequency value is at least one evolved universal mobile telecommunications system (UMTS) terrestrial radio access (E-UTRA) absolute radio frequency channel number (EARFCN).

12. The system of claim 9, wherein identifying the geographic area further comprises identifying, based on the total number of PCIs being greater than the threshold number of PCIs, and the average SINR value being less than a threshold SNIR level, the geographic area.

13. The system of claim 9, the operations further comprising:
identifying a load level associated with a sector to which the UE is latched; and
identifying, based on the load level, a sector rank identifier indicating the sector, the layer being mapped to the sector based on the sector rank identifier and the layer rank identifier.

14. The system of claim 9, wherein, the layer is a first layer, the bandwidth level is a first bandwidth level, and identifying the layer rank identifier further comprises:
identifying the layer rank identifier as a first layer rank identifier;
identifying a second layer rank identifier associated with a second layer based on a second bandwidth level associated with the second layer;
identifying the first layer as a selected layer, based on the first bandwidth level being greater than the second bandwidth level; and
identifying the first layer rank identifier indicating the layer based on the first layer being identified as the selected layer.

15. The system of claim 9, wherein identifying the layer rank identifier further comprises:
identifying the layer rank identifier indicating the layer to which a sector is mapped, based on the UE being latched to the sector.

16. The system of claim 9, wherein the layer is a first layer mapped to a first sector, the bandwidth level is a first bandwidth level, and identifying the layer rank identifier further comprises:
identifying a second bandwidth level associated with a second layer mapped to a second sector;
identifying a first load level associated with the first sector and a second load level associated with a second sector; and
identifying the layer rank identifier indicating the first layer, based on the first bandwidth level being less than the second bandwidth level, and the first load level being greater than the second load level.

17. A server, comprising:
at least one processor; and
memory storing instructions that, when executed by the at least one processor, cause the at least one processor to perform operations comprising:
receiving signal information associated with at least one user equipment (UE) located in a geographic area;
identifying a total number of PCIs in the at least one PCI, and an average signal to interference plus noise ratio (SINR) value associated with the geographic area, the at least one PCI being included in a handover window and being associated with at least one carrier frequency value, the average SINR value being associated with the at least one SINR value of the at least one UE;
identifying, based on at least one of the total number of PCIs being greater than a threshold number of PCIs, or the average SINR value being less than a threshold SNIR level, the geographic area;
identifying a layer rank identifier indicating a layer based on a bandwidth level associated with the layer; and
transmitting, to the UE, a signal including the layer rank identifier.

18. The server of claim 17, wherein the signal information includes at least one physical cell identity (PCI) and at least one SINR value associated with the geographic area.

19. The server of claim 17, wherein identifying the geographic area further comprises identifying, based on the total number of PCIs being greater than the threshold number of PCIs, and the average SINR value being less than a threshold SNIR level, the geographic area.

20. The server of claim 17, the operations further comprising:
identifying a load level associated with a sector to which the UE is latched; and
identifying, based on the load level, a sector rank identifier indicating the sector, the layer being mapped to the sector based on the sector rank identifier and the layer rank identifier.
